(19) United States
(12) Patent Application Publication
(10) Pub. No.: US 2026/0096705 A1
(43) Pub. Date: Apr. 9, 2026

(54) METHOD OF DETERMINING A VALUE OF A FILTER LOADING OF A FILTER OF AN AIR-MOVING DEVICE

(71) Applicant: Dyson Technology Limited, Malmesbury, Wiltshire (GB)

(72) Inventor: Máté HORVÁT, Swindon (GB)

(21) Appl. No.: 19/110,443

(22) PCT Filed: Sep. 11, 2023
(86) PCT No.: PCT/IB2023/058993

§ 371 Date: Mar. 11, 2025

(30) Foreign Application Priority Data
Sep. 13, 2022 (GB) 2213327.6

(51) Int. Cl. A47L 9/19; A47L 9/28; B01D 46/44

(52) U.S. Cl. CPC A47L 9/19; A47L 9/2821; A47L 9/2831; B01D 46/446; B01D 2279/55

(57) ABSTRACT

A method of determining a value of a filter loading of a filter of an air-moving device comprises performing a measurement process comprising determining a first value of an operating parameter of the air-moving device, the first value being a value of the operating parameter when the air-moving device is operating with a first inlet restriction condition. The method comprises performing a determination process to determine the value of the filter loading of the filter of the air-moving device. The determination process comprises determining, based on the first value of the operating parameter and a first pre-determined relationship relating, for the air-moving device when operating with the first inlet restriction condition, values of the operating parameter to values of the filter loading, the value of the filter loading.

### FIELD OF THE INVENTION

The present invention relates to method of determining a value of a filter loading of a filter of an air-moving device, a set of machine-readable instructions for causing the method to be performed, and an air-moving device having a storage comprising such instructions and a processor configured to perform the method by executing the instructions.

### BACKGROUND OF THE INVENTION

There is a general desire to improve air-moving devices, such as vacuum cleaners, in a number of ways. For example, improvements may be desired in terms of efficiency, manufacturing cost, flexibility of use and reliability.

### SUMMARY OF THE INVENTION

According to a first aspect of the invention, there is provided a method of determining a value of a filter loading of a filter of an air-moving device, the method comprising: performing a measurement process comprising determining a first value of an operating parameter of the air-moving device, the first value being a value of the operating parameter when the air-moving device is operating with a first inlet restriction condition; and performing a determination process to determine the value of the filter loading of the filter of the air-moving device, the determination process comprising determining, based on the first value of the operating parameter and a first pre-determined relationship relating, for the air-moving device when operating with the first inlet restriction condition, values of the operating parameter to values of the filter loading, the value of the filter loading.

The filter loading may be a level of loading of a filter which filters particulate matter from the airflow which passes through the motor. For example, the filter loading may be a level of loading of a pre-motor filter. The level of loading may define a dynamic restriction to airflow which is provided by the filter, e.g. due to dirt collected by the filter obstructing the airflow.

Determining the value of the filter loading based on a first pre-determined relationship between values of an operating parameter and values of the filter loading, when the air-moving device is operating with a given inlet restriction condition, may allow for the value of the filter loading to be determined robustly and accurately based on an observable parameter of the device which is correlated with the value of the filter loading. It may also allow for the value of the filter loading to be obtained, based on the measured value of the operating parameter, without, for example, introducing to the device the capability to directly measure a pressure across the filter in order to determine the level of filter loading. The method may allow for flexible determination of the value of the filter loading by use of an operating parameter which is obtained for other purposes during the operation of the device and which may be reused to determine the value of the filter loading. Since the first pre-determined relationship takes into account, in the relationship between values of the operating parameter and values of the filter loading, the inlet restriction, the first pre-determined relationship allows for an accurate and reliable way of translating values of the operating parameter to values of the filter loading across various different inlet restriction conditions.

The operating parameter may be: an operating pressure of a motor of the air-moving device; a speed of the motor of the air-moving device; or an airflow rate through the motor of the air-moving device.

Determining the value of the filter loading based on the operating pressure of the motor or the speed of the motor may allow the filter loading to be determined reliably and accurately, based on an observable physical parameter which is correlated in a pre-determined manner with the value of the filter loading. Both the operating pressure of the motor and the speed of the motor may be parameters which can be reliably measured and which may be determined for other purposes, for example for monitoring a power output of the device. Thus, the use of these parameters to determine the value of the filter loading may obviate the need for additional sensors or processing to perform this task.

The operating parameter may be the operating pressure of the motor of the air-moving device and the first value of the operating parameter may be a first value of the operating pressure of the motor, and the measurement process may comprise determining the first value of the operating pressure of the motor based on: an ambient pressure measurement; and a motor-inlet pressure measurement during operation of the motor.

Determining the first value of the operating pressure based on an ambient pressure measurement and a motor-inlet pressure measurement during operation of the motor may provide for the value of the first operating pressure to be a differential operating pressure which correlates in a reliable and accurate way with the level of filter loading under a given inlet restriction condition. It may also allow measurements taken for other purposes relating to the operation of the air-moving device, for example, the ambient pressure, to be used to obtain the first value of the operating pressure of the motor.

The ambient pressure measurement and the motor-inlet pressure measurement may be measured at different times by a single pressure sensor.

Measuring the ambient pressure measurement and the motor-inlet pressure measurement at different times by a single pressure sensor may allow the first value of the operating pressure to be obtained by use of a single pressure sensor. This may allow for the operating pressure to be measured in a cost- and space-efficient manner.

The operating parameter may be the operating pressure of the motor of the air-moving device and the first value of the operating parameter may be a first value of the operating pressure of the motor, and the measurement process may comprise determining the first value of the operating pressure of the motor based on: a first pressure measurement of a pressure at a first position in a motor assembly in which the motor is located; and a second pressure measurement of a pressure at a second position in the motor assembly; wherein the second position is downstream of the first position.

Using a pressure measurement upstream of the motor and a pressure measurement downstream of the motor may allow for an accurate and reliable measurement of the operating pressure to be obtained in a simple manner.

The first inlet restriction condition may be indicative of a minimum value of an inlet restriction of the air-moving device.

Determining the filter loading by use of values corresponding to a minimum value of an inlet restriction of the air-moving device may provide for a reliable mapping between the values of the operating parameter and values of the filter loading.

The first value may be a minimum value of the operating parameter.

Using the minimum value of the operating parameter to obtain the value of the filter loading may allow for the value of the filter loading to be efficiently and reliably determined by use of a parameter which maps in a consistent and robust manner to values of the filter loading.

The determining the first value of the operating parameter may comprise: determining a plurality of values of the operating parameter; determining a distribution of the plurality of values of the operating parameter; determining a first property of the distribution; and determining, based on the first property of the distribution, the first value of the operating parameter.

This may provide an effective way of obtaining the first value of the operating parameter which maps well to a value of filter loading. By determining the first value from a property of a distribution of values of the operating parameter, pre-determined information regarding a probability distribution of values of the inlet restriction of the air-moving device during operation may be taken into account in order to facilitate corresponding the first value with a pre-determined value of the inlet restriction.

The first property of the distribution may be a minimum value in the distribution.

The minimum value in the distribution may be efficient to determine and may correlate well to values of filter loading.

The distribution of values of the operating parameter may be a rolling distribution.

This may facilitate updating the determination of the value of the filter loading during operation of the air-moving device. For example, by only considering values of the operating parameter from a most recent given timeframe in determining the value of the filter loading, changes in the property of the distribution, which may indicate changes in the value of the filter loading, can be determined, while the determination of the value of the filter loading can still be reliably obtained on the basis of a distribution of values.

The first inlet restriction condition may be an inlet restriction condition of the air-moving device when operating in a pre-determined operating condition.

This may facilitate the use of a determination of or assumption about an operating condition of the device to be used to improve the determination of the value of the filter loading.

The pre-determined operating condition may be indicative of a type of tool attached to the device.

The type of tool which is attached to the device may be a factor which influences the inlet restriction of the device.

The method may comprise: selecting, based on the pre-determined operating condition, the first pre-determined relationship.

This may allow for a more reliable and accurate determination of the value of the filter loading by taking into account the operating condition of the device. For example, if it is determined that a given tool is attached to the device, the first pre-determined relationship may be selected as a relationship which applies for the pre-determined operating condition, e.g. when a given tool of a given type is attached to the device.

The method may comprise: detecting, based on a change in the first value of the operating parameter, a transition between a first pre-determined operating condition and a second pre-determined operating condition.

This may allow for changes in the first value to be used to detect a change in the operating condition of the device. This may allow steps to be taken on the basis of the determination, such as selecting a pre-determined condition relating values of the operating parameter to values of the filter loading which is appropriate for the new operating condition of the device.

The determination process may comprise determining a first normalised value of the operating parameter by normalising the first value of the operating parameter by use of one or more values of one or more respective normalisation parameters, and, in the determination process: the first pre-determined relationship may be between normalised values of the operating parameter and values of the filter loading; and the determining the value of the filter loading may be on the basis of the first normalised value of the operating parameter.

Normalising values of the operating parameter by use of one or more normalisation parameters may provide an efficient way of obtaining values which map robustly and accurately to values of the value of the filter loading of the air-moving device.

The one or more normalisation parameters may comprise one or more of: an ambient pressure; an ambient temperature; a motor input power; and a build tolerance of the air-moving device.

These parameters may be readily determinable, for example by use or sensors, or may be pre-determined, for example by a calibration procedure. Normalising the value of the operating parameter by use of these parameters may provide for first values of the operating parameter to be effectively mapped to values of the filter loading.

The method may comprise issuing, based on the determined value of the filter loading, a filter-loading alert to a user of the air-moving device.

This may allow for the determined value of the filter loading to be used to alert a user of a particular condition of the filter, for example, altering the user that the filter loading has reached a threshold at which the filter should be washed or replaced.

According to a second aspect of the invention, there is provided a set of machine-readable instructions which when executed by a processor of an air-moving device cause the air-moving device to perform a method according to the first aspect of the invention.

According to a third aspect of the invention, there is provided an air-moving device comprising: a processor; and a storage comprising a set of machine-readable instructions which when executed by the processor cause the processor to perform a method according to the first aspect of the invention.

The air-moving device may be a vacuum cleaner.

Optional features of aspects of the present invention may be equally applied to other aspects of the present invention, where appropriate.

### BRIEF DESCRIPTION OF THE DRAWINGS

The present invention will now be described, by way of example only, with reference to the following figures, in which:

FIG. 1 shows a schematic representation of an example motor assembly of an air-moving device;

FIG. 2 shows an example of an air-moving device;

FIG. 3 is a flow chart representation of a method to determine a value of a filter loading of an air-moving device;

FIG. 4 shows an example of a plot of values of an operating pressure and values of an inlet restriction;

FIG. 5 shows further examples of plots of values of the operating pressure and values of the inlet restriction;

FIG. 6 illustrates, schematically, aspects of an example method of determining the value of the filter loading;

FIG. 7 illustrates, schematically, further aspects of the example method shown in FIG. 6;

FIG. 8 illustrates, schematically, further aspects of the example method shown in FIGS. 6 and 7;

FIGS. 9A and 9B illustrate yet further aspects of the example method shown in FIGS. 6 to 8;

FIG. 10 shows a schematic representation of another example motor assembly of an air-moving device;

FIG. 11 shows a schematic representation of another example motor assembly of an air-moving device;

FIG. 12 shows a schematic representation of certain components of a motor assembly of an air-moving device according to an example; and

FIG. 13 shows a schematic representation of certain components of an example motor assembly of an air-moving device according to another example.

### DETAILED DESCRIPTION OF THE INVENTION

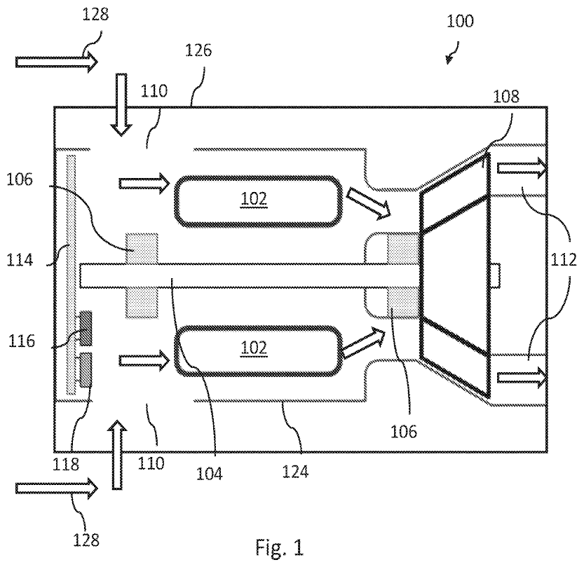

FIG. 1 shows an example schematic representation of a motor assembly 100 of an air-moving device. The motor assembly 100 comprises set of coils 102, a shaft 104 with magnets (not shown) mounted thereon, bearings 106 and an impeller 108. The motor assembly 100 comprises motor air inlets 110, and air outlets/diffuser 112. The motor assembly comprises a circuit board 114 on which are mounted sensor an ambient temperature sensor 116 and a first pressure sensor 118. The motor assembly 100 comprises a housing 124 in which the other components are housed. The motor assembly 100 further comprises a pre-motor filter 126 for filtering air which is drawn into the motor in use.

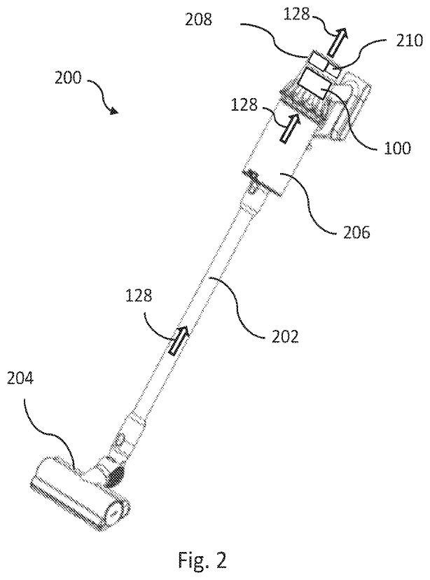

FIG. 2 shows an example air-moving device 200 comprising the motor assembly 100. The air-moving device 200 is a vacuum cleaner. The vacuum cleaner 200 comprises an inlet tube 202 with a tool 204 attached to a distal end of the inlet tube 202. The tool 204 is for engaging with a surface to be cleaned by the vacuum cleaner and comprises an air inlet (not shown) to the vacuum cleaner 200. The tool 204 may be active, comprising one or more mechanically-operated components, e.g. a rotating brush bar, to assist with cleaning tasks. Alternatively, the tool 204 may be passive and not comprise any such mechanically-operated components. A passive tool may nevertheless comprise elements such as bristles or the like to assist with cleaning tasks. In examples, the inlet tube 202 or a portion thereof may be removable. A tool, such as a passive tool, may be attached to the device 200 when the inlet tube 202 or the portion thereof is removed. The vacuum cleaner 200 also comprises a dirt-separating chamber 206, which may, for example, be a cyclone chamber. The vacuum cleaner 200 further comprises a processor 208 and a storage 210 for storing machine-readable instructions for execution by the processor 208 to control operation of components of the vacuum cleaner 200 including the motor 100. The machine-readable instructions when executed may cause the processor 208 to carry out any of the example methods described herein.

In use, the motor of the motor assembly 100 draws air through the air inlet to the air-moving device 200, through the air-moving device 200, and out of an exhaust. Air is drawn through the device 200 along an airflow path 128 which passes through the inlet tube 202, through the dirt-separating chamber 206, through the motor assembly 100 and exits the device 200 through an exhaust.

Returning to FIG. 1, when the motor is in use in the air-moving device 200, an electric current is passed through the coils 102, in a manner which causes the generation of a varying magnetic field. This varying magnetic field is configured to act on the magnets 106 on the shaft 104 to cause the shaft 104 to rotate about its longitudinal axis. This in turn rotates the impeller 108. Air, driven by the impeller 108, is drawn into the air-moving device 200 and along the airflow path 128. The airflow path 128 enters the motor assembly 100, passing through the pre-motor filter 126, which removes particulate matter from the air, and into the housing 124 through the air inlets 110. The airflow path 128 continues through the motor to the impeller 108 and, after passing over the impeller 108, exits the motor assembly 100 through the air outlets 112.

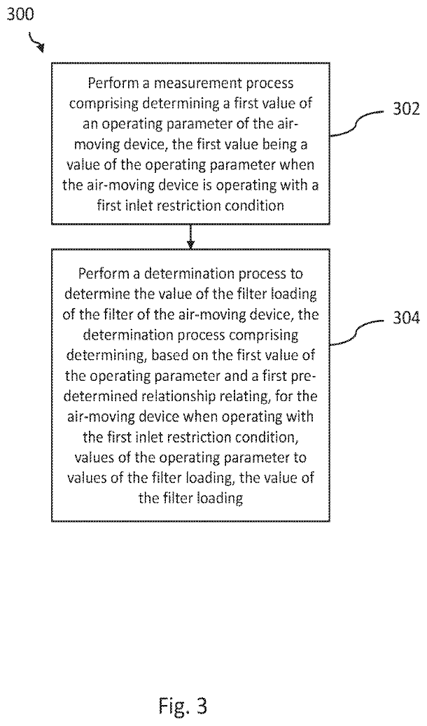

FIG. 3 shows a flow chart representation of an example method 300 to determine a value of the filter loading of the air-moving device 200.

The filter loading may be a level of loading of a filter which filters particulate matter from the airflow which passes through the motor. For example, the filter loading may be a level of loading of the pre-motor filter 126. Alternatively, the filter loading may be a level of loading a post-motor filter or may take into account a level of loading of a plurality of filters, e.g. a pre-motor filter and a post-motor filter. The level of loading of the filter may define how much dirt has been collected by the filter. In examples, this may be expressed in terms of the amount of dirt the filter may collect before it is deemed in need of replacing or cleaning. For example, a filter loading of 100% may represent that the filter has collected an amount of dirt such that it is deemed in need of replacing or cleaning. A filter loading level of 0% may represent that the filter has collected no dirt, e.g. because it has been fully cleaned or newly replaced. Typically, the level of filter loading may increase steadily during use of the device 200 as air passes through the device and dirt is filtered from the air.

The method 300 comprises, at block 302, performing a measurement process comprising determining a first value of an operating parameter of the air-moving device, the first value being a value of the operating parameter when the air-moving device is operating with a first inlet restriction condition.

The operating parameter may be an operating pressure of the motor of the air-moving device 200.

The operating pressure of the motor is an air pressure relating to the motor when the motor is in operation, i.e. when the motor is running. The operating pressure may relate to an air pressure at one or more locations along the airflow path 128. The operating pressure may be a differential air pressure. The operating pressure may, for example, be a pressure difference between an upstream and a downstream location, in the motor assembly, along the airflow path 128.

In another example, the operating pressure is a difference between a first pressure measured when the motor is not running and a second pressure measured when the motor is running. The first pressure and the second pressure may be measured at the same location. A value of an operating pressure may, for example, be obtained by determining a difference between an ambient pressure measurement, taken when the motor is not running, e.g. before start-up of the air-moving device 200, and a pressure measurement taken during operation of the motor. In some examples described herein, such an operating pressure is referred to as delta-P. The pressure measurement taken during operation of the motor may, for example, be taken at the air inlet 110. Alternatively, the measurement may be taken at an air outlet from the motor. In some examples, the pressure measurements used to obtain a value of an operating pressure may be taken by the same pressure sensor. This allows for a value of the operating pressure to be obtained using a single pressure sensor, which may be cost- and space-efficient.

Examples of methods of obtaining operating pressure measurements will be described in more detail below.

In other examples, the operating parameter may be a parameter other than an operating pressure, such as a speed of the motor of the air-moving device 200. This speed may be measured, for example, by a suitable sensor (not shown in the figures). In other examples, the operating parameter may be an airflow rate through the device 200. An example of determining an airflow rate will be described below.

The inlet restriction of the air-moving device 200 is a level of restriction acting on the air inlet through which air flows into the device 200. The level of inlet restriction may vary based on various factors such as obstructions blocking the flow of air into the device 200. For example, the inlet restriction may vary depending on a type of surface the vacuum cleaner 200 is being used to clean. For instance, a carpeted surface or similar may place a greater restriction on the flow of air into the vacuum cleaner 200 than a smooth surface such as a wood or tile surface. The level of the inlet restriction may also vary depending on a type of tool attached to the vacuum cleaner 200. Different tools may, for example, have different geometries and thus restrict the flow of airflow into the vacuum cleaner 200 by different amounts. For example, different tools may have different air inlet diameters. Further, certain tools may include elements which obstruct the flow of air-flow into the device 200, such as bristles for cleaning carpet, while other tools may not include such elements.

The first inlet restriction condition may be indicative of a minimum level of an inlet restriction of the air-moving device 200. For example, the first value of the operating parameter may be a value of the operating parameter measured when the air-moving device 200 is operating with a minimum level of inlet restriction, or, equivalently, with a maximum equivalent orifice diameter. This minimum level of inlet restriction may correspond to the device 200 operating in free air. That is, the minimum level of inlet restriction may be the level of inlet restriction acting on the device 200 when a tool of the vacuum cleaner is not engaged with a surface, such that there is no external obstruction to the flow of air into the device 200.

In other examples, the first inlet restriction condition may be a known property of a distribution of inlet restriction values of the device 200. For example, a mean or mode inlet restriction value of the device 200 over a period of operation may be determined. The first value of the operating parameter may then be a value measured when the device 200 is operating with the mean or mode inlet restriction value.

The method 300 also comprises, at block 304, performing a determination process to determine the value of the filter loading of the filter of the air-moving device 200. The determination process comprises determining, based on the first value of the operating parameter and a first pre-determined relationship relating, for the air-moving device 200 when operating with the first inlet restriction condition, values of the operating parameter to values of the filter loading, the value of the filter loading.

The first pre-determined relationship may comprise a relationship defined by a curve relating values of the operating parameter of the motor and values of an inlet restriction of the air-moving device 200.

The relationship between values of the operating parameter and values of the inlet restriction may be obtained, for example, by a calibration process. This calibration process may involve, for example, operating the device 200 under known operating conditions, including a known value of inlet restriction, and measuring values of the operating parameter. This may be done by operating the device 200 with orifice plates having orifices of differing diameters restricting airflow into the device 200. The value of inlet restriction of the device in operation may then be defined in terms of the diameter of the orifice which would provide an equivalent level of restriction to airflow into the device 200. As an example, the vacuum cleaner 200 when being used to clean a carpeted surface may be operating under a high level of inlet restriction which may be equivalent to operating in known conditions with an orifice plate having an orifice of small diameter restricting airflow into the vacuum cleaner 200. Conversely, the vacuum cleaner 200 when cleaning a wood surface may be operating under a lower level of inlet restriction, equivalent to that presented by an orifice of larger diameter.

Values of the operating parameter of the motor and values of one or more further parameters to values of the inlet restriction of the air-moving device may be related by a pre-determined relationship. The value of the inlet restriction may then be determined based on a first value of the operating parameter and respective values of the one or more further parameters. The further parameters may be parameters of the air-moving device 200 which influence the value of the operating parameter which is measured for a given value of the inlet restriction. For example, different values for parameters such as the ambient pressure, ambient temperature, motor input power, the filter loading, and build tolerance of the air-moving device may result in different values of the operating parameter for the same value of inlet restriction.

Ambient pressure and ambient temperature form part of the external conditions under which the device 200 is operating. In some examples, ambient pressure may be measured prior to start-up of the motor by the first pressure sensor 118. Ambient temperature may be measured by the temperature sensor 116. Motor input power is the power which is supplied to drive the motor.

The motor input power may be controlled by the processor 208 and supply a DC or AC power, for example from a battery (not shown) of the device 200 or from a mains supply. The motor input power may control the suction power of the air-moving device.

The build tolerance of the air-moving device 200 may account for the variability in operation between different devices. For example, various operating parameters of the device may be measured during a calibration process following assembly of the device. The build tolerance of a particular device may be expressed as a percentage of a total allowable tolerance. In one example, at an end of a production line for a device, an orifice plate having an orifice of a given diameter is connected to an inlet of the device, wherein the device is known to have clean filters, i.e. the filter loading value is 0%. The ambient temperature and pressure are measured. The device is operated at a given power level and the operating parameter, e.g. delta-P, is measured. With values of the input power, ambient temperature, ambient pressure, filter loading, being measured or otherwise known, the measured delta-P is indicative of the build tolerance factor. This process may be repeated at multiple power levels and at different orifice diameters.

In some examples, the normalised values of the operating pressure are obtained by normalising values of the operating parameter with respect to one or more further parameters, such as those mentioned above. For example, a five-dimensional look-up table may be defined which maps respective values of build tolerance, ambient pressure, ambient temperature, motor input power, and a value of the operating pressure to a normalised value of the operating pressure.

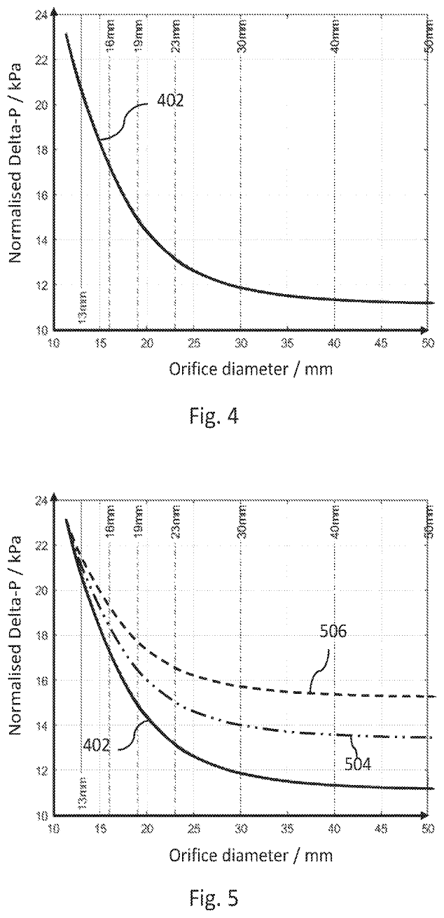

An example of a curve relating normalised values of the operating pressure to the values of inlet restriction is shown in FIG. 4. This example is for the motor of a vacuum cleaner.

In the example of FIG. 4, the operating parameter, shown on the y-axis, is an operating pressure, namely a delta-P value, defining a difference between an ambient pressure of the motor prior to start-up and a pressure at a motor inlet during operation. Delta-P is in units of kPa. The values of the inlet restriction are in terms of orifice diameter, in millimetres. A first curve 402 mapping values of normalised delta-P to values of inlet restriction has been obtained by a suitable calibration process involving operating the vacuum cleaner under known conditions with inlet restriction provided by orifices of various diameter. Corresponding values of the diameter of the orifice and delta-P have been measured. The first curve 402 has been obtained by normalising values of delta-P with respect to values of build tolerance, ambient pressure, ambient temperature and motor input power. The first curve 402 uniquely maps a normalised value of the operating pressure to a value of the inlet restriction. However, as will be described with reference to FIG. 5, the normalised value of the operating pressure does not take into account a value of the filter loading of the motor. Accordingly, different values of the filter loading will result in a different mapping between values of normalised operating pressure and values of the inlet restriction.

FIG. 5 shows a set of curves 402, 504, 506 relating normalised values of the operating pressure to values of the inlet restriction. Each curve corresponds to a different value of filter loading. The first curve 402 of FIG. 4 is also shown in FIG. 5 and corresponds to a value of filter loading of 0%. A second curve 504 corresponds to a value of filter loading of 50%. A third curve 506 corresponds to a value of filter loading of 100%. To determine the value of the inlet restriction, using the set of curves 402, 504, 506, one of the curves 402, 504, 506 may be selected based on a given value of the filter loading. The normalised value of the operating pressure then uniquely determines a value of the inlet restriction for the known value of the filter loading.

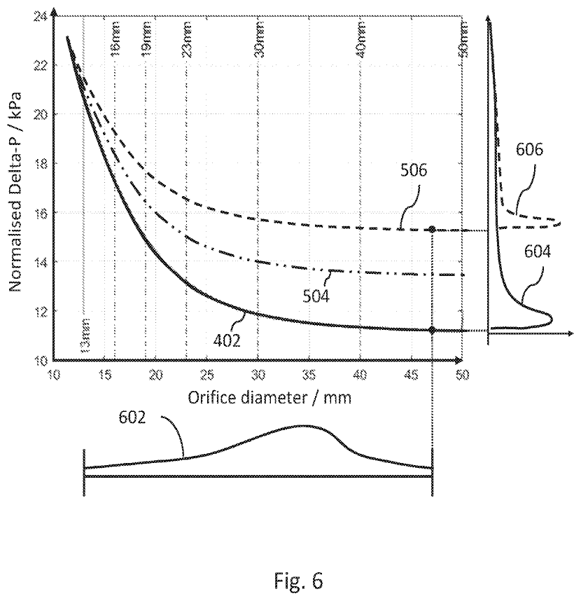

An example of a determination process for determining a value of a filter loading will now be described with reference to FIG. 6. FIG. 6 shows the set of normalised delta-P curves 402, 504, 506 described above with reference to FIG. 5. FIG. 6 shows a first probability distribution 602 of applicable inlet restriction values of the vacuum cleaner. The first probability distribution 602 represents the probability of the vacuum cleaner having a given level of inlet restriction, in terms of an equivalent orifice diameter, when operating with a first tool attached. This first probability distribution 602 corresponds to a passive tool comprising a relatively wide nozzle and a selectively engageable brush. As can be seen from FIG. 6, in this example, the inlet restriction values of the first probability distribution 602 range from around 13 mm to around 47 mm. The minimum level of inlet restriction in the first probability distribution 602 corresponds to an orifice diameter of around 47 mm.

FIG. 6 also shows respective projections of the first probability distribution 602 onto two 402, 506 of the normalised delta-P curves. A first projection 604 is a projection of the first probability distribution 602 onto the first curve 402, which, as described above, corresponds to a filter loading of 0%. A second projection 604 is a projection of the first probability distribution 602 the third curve 506, which, as described above, corresponds to a filter loading of 100%.

The projections 604, 606 define respective probability distributions of the measured normalised value of delta-P for filter loading values of 0% and 100% respectively. In other words, the first projection 604 defines the probability of measuring a given normalised value of delta-P when the device is operating with 0% filter loading. Similarly, the second projection 606 defines the probability of measuring a given normalised value of delta-P when the device is operating with 100% filter loading. Further projections, not shown in FIG. 6, can be defined, defining the probability distributions of normalised delta-P at different values of filter loading, e.g. 25%, 50%, 75%, etc.

The values of normalised delta-P defined by the curves 402, 504, 506, in general, decrease rapidly for low values of orifice diameter but begin to level off for high values of orifice diameter. This levelling off means that a given value of normalised delta-P, at high values of orifice diameter, may map uniquely to a given one of the curves 402, 504, 506. In examples, this property may be used to determine the level of filter loading from a measured value of normalised delta-P.

For example, from the first probability distribution 602, it is known that the minimum normalised delta-P values in the probability distributions 604, 606 correspond to the device operating with a known maximum orifice diameter, in this example of around 47 mm. To determine a filter loading value, a minimum value of normalised delta-P during operation of the vacuum cleaner may be measured and mapped to given one of the curves 402, 504, 506 at the known maximum orifice diameter. By determining which of the curves 402, 504, 506, the measured normalised delta-P value maps to, the value of the filter loading can be determined.

For example, in FIG. 6, the third curve 506 and the probability distribution 606 show that, for a filter loading value of 100%, the minimum value of normalised delta-P, which corresponds to the maximum orifice diameter value of around 47 mm, is around 15.3 kPa. Accordingly, if the minimum normalised value of delta-P of the vacuum cleaner is measured to be around 15.3 kPa, this is indicative that the filter loading is 100%. Similarly, the first curve 402 and the probability distribution 604 show that, for a filter loading value of 0%, the minimum normalised delta-P value, again which corresponds to the maximum orifice diameter value of around 47 mm, is around 11.2 kPa. A measurement for the minimum normalised value of delta-P of around 11.2 kPa is therefore indicative that the value of the filter loading is 0%.

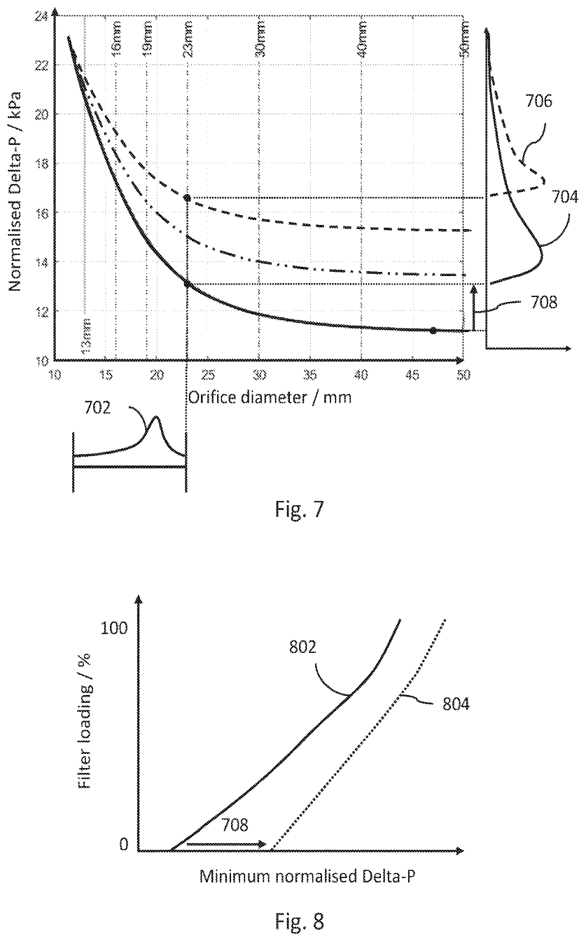

FIG. 7 illustrates another example of a method of determining a filter loading value. FIG. 7 is similar to FIG. 6 but relates to the vacuum cleaner when operating with a second tool attached. FIG. 7 shows a second probability distribution 702 of inlet restriction values applicable when the vacuum cleaner is in use with the second tool. Similarly to as described above with reference to FIG. 6, FIG. 7 shows projections 704, 706 of the second probability distribution 702 onto the first curve 402 and the third curve 506 respectively. As described above with reference to FIG. 6, the value of the filter loading can be determined by measuring the minimum normalised delta-P value of the vacuum cleaner in use. It can then be determined to which of a plurality of curves, e.g. the curves 402, 504, 506, this minimum value maps. The curve to which the minimum normalised delta-P value maps is indicative of the value of the filter loading.

From a comparison of the second probability distribution 702 and the first probability distribution 602, it can be seen that the second tool generally provides a higher level of inlet restriction than the first tool. The second tool may, for example, be a passive, crevice tool. In this example, a minimum level of inlet restriction provided by the second tool corresponds to an orifice diameter of around 23 mm, compared to a value of around 47 mm for the first tool. As a consequence, the minimum normalised delta-P value for a given filter loading value is greater when using the second tool than when using the first tool. For example, when using the second tool, the minimum normalised delta-P value at a filter loading of 100% is around 16.5 kPa and the minimum normalised delta-P value at a filter loading of 0% is around 13.2 kPa. FIG. 7 shows this difference 708 in the minimum normalised delta-P value for a filter loading of 0% when using the first tool and when using the second tool by way of an arrow. In some examples, this difference in minimum normalised delta-P values at the same filter loading value may be used to determine when a tool which is attached to the device is changed.

FIG. 8 shows a plot of filter loading values, on the y-axis, and minimum normalised delta-P values on the x-axis. FIG. 8 shows a first filter loading curve 802 which corresponds to the first tool and a second filter loading curve 804 which corresponds to the second tool. FIG. 8 illustrates how a minimum normalised value of delta-P maps to a given filter loading value for the first tool and the second tool. FIG. 8 shows the difference 708 between the minimum normalised delta-P values for the first tool and the second tool at a filter loading value of 0%. As described above, typically values of the filter loading change gradually as the filter gathers more dirt during use of the device. Accordingly, sudden relatively large changes in a determined value of the filter loading may be generally not expected to occur unless an operating condition of the device changes. If such a sudden change is detected, then in some examples, this change may be taken to indicate a change in an operating condition of the device. For example, a detected sudden change in a determined value of the minimum normalised delta-P may be taken to be indicative of a change in the tool which is attached to the vacuum cleaner. For example, if the measured minimum normalised delta-P value changes by the difference 708 over a relatively short period of usage of the device, this may be taken to indicate that the vacuum cleaner has transitioned from an operating state in which the first tool is attached to an operating state in which the second tool is attached. Further, the correct filter loading curve to be used to relate minimum normalised delta-P values to filter loading values can be determined based on the type of tool which is attached to the device, e.g. if it is known which type of tool is attached to the device. For example, after a detected change 708 in the determined minimum normalised delta-P value, the device may move from determining the value of filter loading using the first filter loading curve 802 to determining the value of filter loading using the second filter loading curve 804.

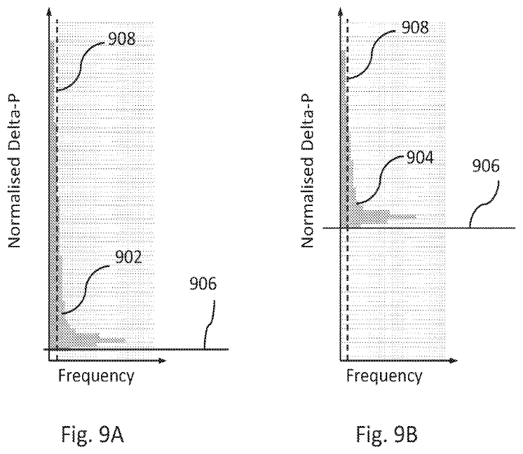

FIGS. 9A and 9B show examples of probability distributions 902, 904 of normalised delta-P values when the device 200 is in use with a given tool, e.g. with the first tool. FIG. 9A corresponds to the vacuum cleaner operating with a filter loading value of 0%. FIG. 9B corresponds to the vacuum cleaner operating with a filter loading value of 100%. In an example, to determine such a probability distribution, a fixed number of counters is defined, e.g. 100 counters may be defined. Two one-dimensional arrays are defined, a pressure bin array and a FIFO, first in, first out, array. The FIFO array has a length equal to the fixed number of counters. A value of delta-P is measured and normalised. A counter is added to the pressure bin corresponding to the measured and normalised value. Once all of the counters have been allocated to bins, with the next measurement of normalised delta-P, the oldest allocated counter, which may be the counter in the final position of the FIFO array, is moved to the bin corresponding to the latest measured normalised delta-P value. In this way, a permanent rolling distribution can be maintained. The rolling distribution may be queried at any time and at any frequency. In the example where the minimum value of normalised delta-P is the value which is determined and used to indicate the filter loading value, the lowest populated bin is determined in order to determine the minimum value of normalised delta-P. In some examples, a minimum counter threshold may be set under which counters in a bin are not tallied, such that the lowest populated bin is the lowest bin with at least the threshold number of counters. This may act as a noise filter. In some examples, the distribution may be filtered, e.g. by determining an exponential moving average, to further remove noise. In other examples, the FIFO array may not be defined and, for example, once all of the counters have been allocated, the counters may be removed from the pressure bins and the allocation of counters may start again.

FIGS. 9A and 9B show, by way of example, minimum normalised delta-P values 906 of the distributions 902, 904 which are indicative of filter loading values of 0% and 100% respectively. FIGS. 9A and 9B also show by way of example a threshold counter value 908 below which counters are not tallied for the purposes of determining the lowest populated bin.

The above example has been described with reference to two particular tools. However, it will be appreciated that various different types of tool may be used with the device 200 and that each of these different tools may have an associated probability distribution of inlet restriction values which may be used in a method of determining a value of the filter loading of the device 200. Moreover, the inlet restriction probability distribution of a given tool may vary depending on the usage. However, providing a given property of the probability distribution, e.g. the minimum level of inlet restriction, does not change, the given property may be used to determine the filter loading regardless of other variations in the overall probability distribution.

Although in certain examples described above, the minimum value of the operating parameter is the value used to indicate the value of the level of the filter loading, in other examples other values of the operating parameter may be used to indicate the filter loading value. For example, a different property other than the minimum of a probability distribution of the operating parameter, such as an arithmetic mean, mode or other property, may be determined and used as the value of the operating parameter which indicates the filter loading value.

Examples of the above-described method may allow for the filter loading value to be determined based on a correspondence between filter loading values and an operating parameter of the motor. This may in some examples allow for the filter loading value to be determined without use of further additional sensors, such as pressure sensors upstream and downstream of the filter.

The value of the filter loading may be used for various purposes. For example, a filter loading value may be used to determine an inlet restriction value. In another example, the filter loading value may be used to provide an alert. For example, when the filter loading value reaches a given threshold an alert may be issued indicating that the filter should be washed or replaced.

The method 300 may be performed a plurality of times, e.g. at regular intervals, during operation of the air-moving device. For example, the filter loading value may be determined at regular intervals to be used in control method of the device, such as to control the input power of the motor. Further, the filter loading may be continuously monitored in order to provide an alert when the value reaches a threshold that indicates that cleaning or replacement of the filter is required.

The method may allow for the value of filter loading to be determined robustly and accurately and may be performed without the addition of further sensors, e.g. to measure a pressure difference across the filter. Furthermore, the method may contribute to overall computational efficiency in the control of the device 200 since the parameters needed to determine filter loading may also be used for other purposes, such as to control an input power of the motor.

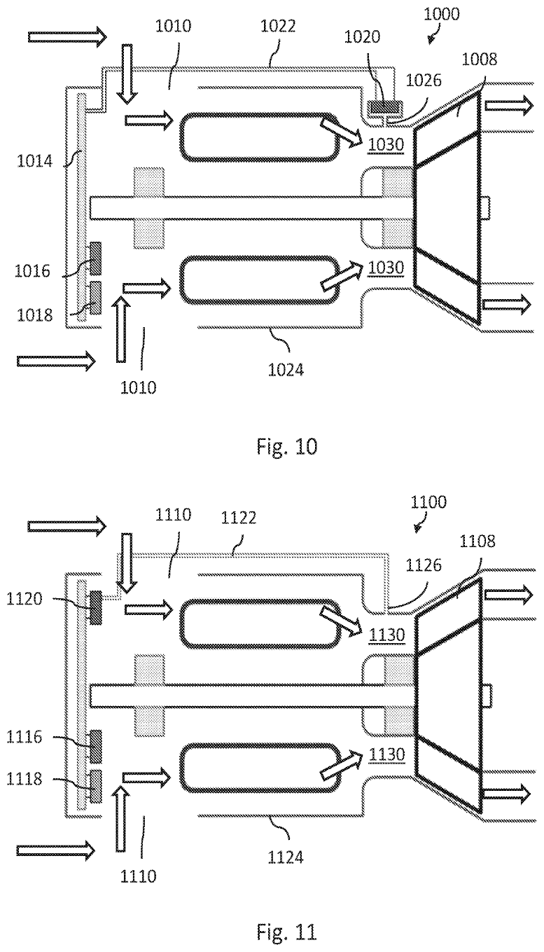

FIG. 10 shows another example schematic representation of a motor assembly 1000. The motor assembly 1000 comprises features corresponding to those of the motor assembly 100 described above with reference to FIG. 1, which, where labelled, are labelled with like reference numbers. The pre-motor filter is not shown in FIG. 10, for the sake of clarity.

The motor assembly 1000 further comprises a second pressure sensor 1020 and wiring 1022 which electrically connects the second pressure sensor 1020 to circuit board 1014. The motor assembly 1000 further comprises an inlet tube 1026 providing a fluid connection, through housing 1024, from the second pressure sensor 1020 to an inlet 1030 of impeller 1008. This allows the second pressure sensor 1020 to take measurements of a pressure at the impeller inlet 1030. As can be seen by the schematic representation of FIG. 10, a cross-sectional area of the motor is narrower at the impeller inlet 1030 than at the motor inlet 1010.

FIG. 11 shows another example motor assembly 1100. The motor assembly 1100 is the same as the motor assembly 1000 of FIG. 10 with the exception that, in the motor assembly 1100 of FIG. 11, the second pressure sensor 1120 is located on the circuit board 1114. A channel or duct 1122 provides a fluid connection between the second pressure sensor 1120 and the impeller inlet 1130. The channel 1122 allows the second pressure sensor 1120 to take measurements of a pressure at the impeller inlet 1130 without the second pressure sensor being located at the impeller inlet 1130.

Such a channel may be provided by various means. In one example, the channel 1126 may be formed by a pipe. The pipe may, for example, extend along an exterior surface of the housing 1124 and extend through a hole 1126 in the housing to provide the fluid connection from the second pressure sensor 1120 to the impeller inlet 1130. At an end of the channel 1126 at which the second pressure sensor 1120 is located, an air-tight seal may be formed around the second pressure sensor 1120. The seal may, for example, comprise a circular, e.g. EPDM, foam seal sealing the pipe to a location on the circuit board 1114 at which the second pressure sensor 1120 is located. A similar seal may be formed around the second pressure sensor 1020 of the motor assembly 1000 of FIG. 10.

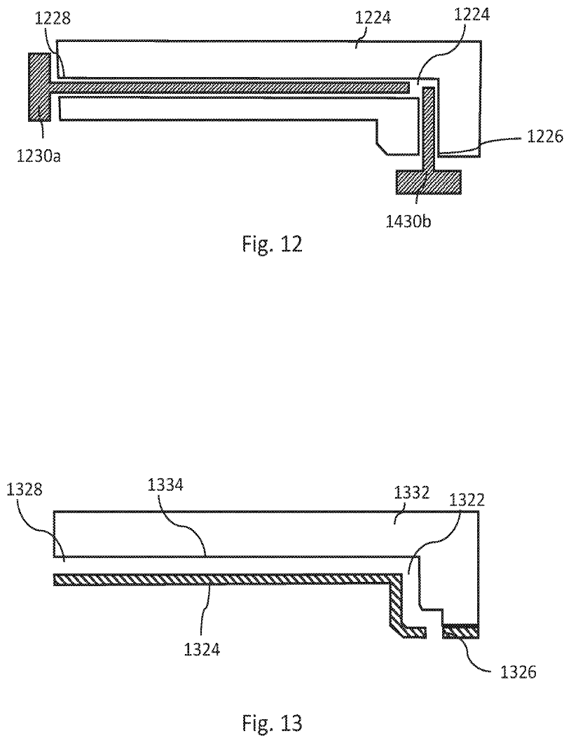

In another example the channel may be integral with the housing of the motor assembly. FIG. 12 shows an example schematic representation of such a housing 1224 with a channel 1222 extending through the housing 1224. In such an example, the housing 1224 may be formed by an injection moulding process, with the channel through the housing 1224 formed during the injection moulding, e.g. by the use of removable pins 1230a, 1230b during the injection moulding. In use, in the manner described with reference to FIG. 11, a hole 1226 through the housing 1224 opens into an impeller inlet of the motor. In use, the second pressure sensor is located at an upstream end 1228 of the channel 1222. This provides a fluid connection via the channel 1222 to the second pressure sensor and allows the second pressure configured to take pressure measurements of the pressure at the impeller inlet. This may allow the second pressure sensor to be conveniently located. The second pressure sensor may, for example, be located on a circuit board of the device. Further, forming the channel 1222 integrally with the housing 1224 may be cost effective and convenient.

In another example, the channel may be formed between an exterior surface of the housing and a mount located against the exterior surface of the housing. FIG. 13 schematically illustrates such an example. In FIG. 13, a mount 1332, e.g. made of rubber, has a groove 1334 therein. The mount 1332 seals in an air-tight manner against an exterior surface of the housing 1324 which has a hole 1326 which, in use, leads to the impeller inlet. A channel 1322 is created by a gap provided by the groove 1334 in the mount 1332 between the mount 1332 and the exterior surface of the housing 1324. In both of the examples of FIG. 12 and FIG. 13, in use, the second pressure sensor is sealed in an air-tight manner to the channel 1222, 1322 at the upstream end 1228, 1328 of the channel 1222, 1322. For example, in the example of FIG. 13, the mount 1332 may be a rubber mount which forms a seal around the second pressure sensor.

In each of the example motor assemblies 1000, 1100, the first pressure sensor 1018, 1118 is positioned to take pressure measurements at the air inlet 1010, 1110. The pressure measurements taken by the first pressure sensor 1018, 1118 include an ambient pressure pₐ which is measured prior to start-up of the motor. Further, the pressure measurements taken by first pressure sensor 1018, 1118 include measurements of a first pressure p₁ taken during running of the motor. The temperature sensor 1016, 1116 is configured to measure an ambient temperature Tₐ. The second pressure sensor 1020, 1120 is configured to take pressure measurements of a second pressure p₂ at the impeller inlet 1030, 1130 during running of the motor. Each of the ambient pressure pₐ, the first pressure p₁ and the second pressure p₂ are absolute pressures.

In an example, measurements taken by the first pressure sensor 1018, 1118 the second pressure sensor 1020, 1120 and the temperature sensor 1016, 1116 may be used to determine a dynamic pressure value. In one example, a dynamic pressure measurement is determined as follows.

A gauge static pressure p_{static} in the motor is determined by subtracting the ambient pressure pₐ from the first pressure p₁. The first pressure p₁ is typically lower than the ambient pressure pₐ because the running of the motor causes a partial vacuum to be generated within the motor housing 1024, 1124.

A gauge total pressure pₜₒₜₐₗ at the impeller inlet is determined by subtracting the second pressure p₂ from the first pressure p₁. The total pressure pₜₒₜₐₗ at the impeller inlet is made up of the static pressure p_{static} and a dynamic pressure p_{dyn}. The second pressure p₂ is typically lower than the first pressure p₁ due to the lower cross-sectional area and associated higher air velocity at the impeller inlet 1030, 1130 as compared with at the motor inlet 1010, 1110.

The dynamic pressure p_{dyn} at the impeller inlet 1030, 1130 is determined by subtracting the static pressure p_{static} in the motor from the total pressure pₜₒₜₐₗ at the impeller inlet 1030, 1130. The dynamic pressure p_{dyn} may also be referred to as an air velocity pressure.

The dynamic pressure p_{dyn}, the first pressure p₁ and the temperature Tₐ are input into a density ratio formula to determine the dynamic pressure value at STP P_{dyn@STP}. The value of p_{dyn@STP} is a dynamic pressure value corrected to standard temperature and pressure. Accordingly, the dynamic pressure value is normalised for the ambient conditions in which the motor is operating. This allows, for example, a single look-up curve to be defined relating dynamic pressure values to airflow rates or other parameters. The applicable density ratio for a given motor may depend on a type of the motor. For example, the following density ratio formulae (1) to (3) apply, respectively, for constant power motors, AC series motors, and constant speed motors:

$${p}_{dyn @ STP} = {P}_{dyn} {( ( \frac{{p}_{1}}{101.325} ) ( \frac{293}{{T}_{a} + 273.15} ) )}^{- ( \frac{2}{3} )} \qquad ( 1 )$$

$${p}_{dyn @ STP} = {P}_{dyn} {( ( \frac{{p}_{1}}{101.325} ) ( \frac{293}{{T}_{a} + 273.15} ) )}^{- ( \frac{5}{6} )} \qquad ( 2 )$$

$${p}_{dyn @ STP} = {P}_{dyn} {( ( \frac{{p}_{1}}{101.325} ) ( \frac{293}{{T}_{a} + 273.15} ) )}^{- ( 1 )} \qquad ( 3 )$$

where p_{dyn@STP}, p₁, and p_{dyn} are in units of kPa, Tₐ is in units of degrees Celsius, 101.325 is standard pressure in units of kPa, 293 is standard temperature in units of Kelvin and 273.15 is 0 degrees Celsius in units of Kelvin.

A determined dynamic pressure value may be mapped to various parameters. For example, the dynamic pressure value may be used as an operating parameter in an example above-described method of determining a filter loading value. In such examples, dynamic pressure values may be mapped to values of inlet restriction for different values of filter loading, e.g. in a similar manner to that described above for delta-P values. Additionally, or alternatively, the dynamic pressure value may be mapped to values of airflow rate through the motor. The airflow rate may also be used an operating parameter in examples of the method described above. The mapping of dynamic pressure values to airflow rate may be determined, for example, by a calibration process. In such a calibration process, the air-moving device may be operated with an airflow rate measuring apparatus, which may comprise a bell mouth, a venturi, or an orifice plate, being used to measure the airflow rate through the device while at the same time measurements are taken which allow dynamic pressure values to be determined which can be corresponded with airflow measurements. Accordingly, when the device is operated after calibration, dynamic pressure values may be determined and mapped to airflow rate values in order to determine the airflow rate through the device in use.

The above embodiments are to be understood as illustrative examples of the invention. Other embodiments are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method of determining a value of a filter loading of a filter of an air-moving device, the method comprising:
performing a measurement process comprising determining a first value of an operating parameter of the air-moving device, the first value being a value of the operating parameter when the air-moving device is operating with a first inlet restriction condition; and
performing a determination process to determine the value of the filter loading of the filter of the air-moving device, the determination process comprising determining, based on the first value of the operating parameter and a first pre-determined relationship relating, for the air-moving device when operating with the first inlet restriction condition, values of the operating parameter to values of the filter loading, the value of the filter loading.

2. The method of claim 1, wherein the operating parameter is:
an operating pressure of a motor of the air-moving device;
a speed of the motor of the air-moving device;
or an airflow rate through the motor of the air-moving device.

3. The method of claim 2, wherein the operating parameter is the operating pressure of the motor of the air-moving device and the first value of the operating parameter is a first value of the operating pressure of the motor, and wherein the measurement process comprises determining the first value of the operating pressure of the motor based on:
an ambient pressure measurement; and
a motor-inlet pressure measurement during operation of the motor.

4. The method according to claim 3, wherein the ambient pressure measurement and the motor-inlet pressure measurement are measured at different times by a single pressure sensor.

5. The method according to claim 2, wherein the operating parameter is the operating pressure of the motor of the air-moving device and the first value of the operating parameter is a first value of the operating pressure of the motor, and wherein the measurement process comprises determining the first value of the operating pressure of the motor based on:
a first pressure measurement of a pressure at a first position in a motor assembly in which the motor is located; and
a second pressure measurement of a pressure at a second position in the motor assembly;
wherein the second position is downstream of the first position.

6. The method of claim 1, wherein the first inlet restriction condition is indicative of a minimum value of an inlet restriction of the air-moving device.

7. The method of claim 1, wherein the first value is a minimum value of the operating parameter.

8. The method of claim 1, wherein the determining the first value of the operating parameter comprises:
determining a plurality of values of the operating parameter;
determining a distribution of the plurality of values of the operating parameter;
determining a first property of the distribution; and
determining, based on the first property of the distribution, the first value of the operating parameter.

9. The method of claim 8, wherein the first property of the distribution is a minimum value in the distribution.

10. The method of claim 8, wherein the distribution of values of the operating parameter is a rolling distribution.

11. The method of claim 1, wherein the first inlet restriction condition is an inlet restriction condition of the air-moving device when operating in a pre-determined operating condition.

12. The method of claim 11, wherein the pre-determined operating condition is indicative of a type of tool attached to the device.

13. The method of claim 11, wherein the method comprises:
selecting, based on the pre-determined operating condition, the first pre-determined relationship.

14. The method of claim 11, wherein the method comprises:
detecting, based on a change in the first value of the operating parameter, a transition between a first pre-determined operating condition and a second pre-determined operating condition.

15. The method of claim 1, wherein the determination process comprises determining a first normalised value of the operating parameter by normalising the first value of the operating parameter by use of one or more values of one or more respective normalisation parameters, and wherein, in the determination process:
the first pre-determined relationship is between normalised values of the operating parameter and values of the filter loading; and
the determining the value of the filter loading is on the basis of the first normalised value of the operating parameter.

16. The method of claim 15, wherein the one or more normalisation parameters comprise one or more of:
an ambient pressure;
an ambient temperature;
a motor input power; and
a build tolerance of the air-moving device.

17. The method of claim 1, comprising:
issuing, based on the determined value of the filter loading, a filter-loading alert to a user of the air-moving device.

18. A set of machine-readable instructions which when executed by a processor of an air-moving device cause the air-moving device to perform a method according to claim 1.

19. An air-moving device comprising:
a processor; and
a storage comprising a set of machine-readable instructions which when executed by the processor cause the processor to perform a method according to claim 1.

20. The air-moving device of claim 19, wherein the air-moving device is a vacuum cleaner.
